(19) United States
(12) Patent Application Publication
(10) Pub. No.: US 2006/0231976 A1
(43) Pub. Date: Oct. 19, 2006

(54) Method for filling a blank into a mold

(75) Inventor: Fa-Shen Chen, Taichung City (TW)

Correspondence Address: TROXELL LAW OFFICE PLLC, 5205 LEESBURG PIKE, SUITE 1404, FALLS CHURCH, VA, 22041, US

(73) Assignee: KING STEEL MACHINERY CO., LTD.

(21) Appl. No.: 11/117,322

(22) Filed: Apr. 29, 2005

(30) Foreign Application Priority Data
Apr. 18, 2005 (TW) 094112250

(51) Int. Cl. B29C 45/14

(52) U.S. Cl. 264/250; 264/255; 264/328.7

(57) ABSTRACT

A method for filling a blank into a mold. The temperature of the mold is previously risen to a predetermined temperature. When the mold is positioned in a mold-opened position, a fluid is used to cool the surface of the mold cavity of the mold into which the blank is to be filled so as to lower the temperature of the surface of the mold cavity. Then blank is placed into the mold cavity and the mold is positioned in a mold-closed position.

### BACKGROUND OF THE INVENTION

The present invention is related to a polymer molding and processing technique, and more particularly to a method for filling a blank into a mold.

Different polymer materials have different properties and polymerization reactions. Therefore, different polymer materials necessitate different molding and processing methods. In some conventional molding and processing techniques for the polymer material, the polymer material is previously made into a fixed amount of blank with a certain shape. Then the blank is placed in a mold and a certain pressure and a certain heat are applied to the blank. Accordingly, the blank of polymer material is polymerized and molded into a specific product with a desired configuration.

However, the above techniques are still not optimal so that the manufacturing efficiency can be hardly enhanced. This is because that the temperature of the mold rises after the blank is filled into the mold. The temperature of the mold rises for giving heat to the polymer material inside the mold so as to provide a necessary reaction temperature. As a result, in the manufacturing procedure, an independent time is necessary for the rise/drop of the temperature of the mold. Therefore, as a whole, the manufacturing efficiency is limited and cannot be promoted.

### SUMMARY OF THE INVENTION

It is therefore a primary object of the present invention to provide a method for filling a blank into a mold. According to the method, in the polymer molding procedure, the time for rising the temperature of the mold is greatly shortened so that the manufacturing time is shortened. Therefore, the manufacturing efficiency of the polymer product can be enhanced.

It is a further object of the present invention to provide the above method for filling the blank into the mold. When the temperature of the mold rises to a certain temperature, the blank is filled into the mold cavity so as to prevent the blank from melting, bending or deforming due to the excessively high temperature of the mold.

According to the above objects, in the method for filling the blank into the mold, the temperature of the mold is previously risen to a predetermined temperature. When the mold is positioned in a mold-opened position, a fluid is used to cool the surface of the mold cavity of the mold into which the blank is to be filled so as to lower the temperature of the surface of the mold cavity. Then blank is placed into the mold cavity and the mold is positioned in a mold-closed position.

The present invention can be best understood through the following description and accompanying drawings wherein:

### BRIEF DESCRIPTION OF THE DRAWING

FIG. 1 is a flow chart of the method of the present invention.

### DETAILED DESCRIPTION OF THE PREFERRED EMBODIMENTS

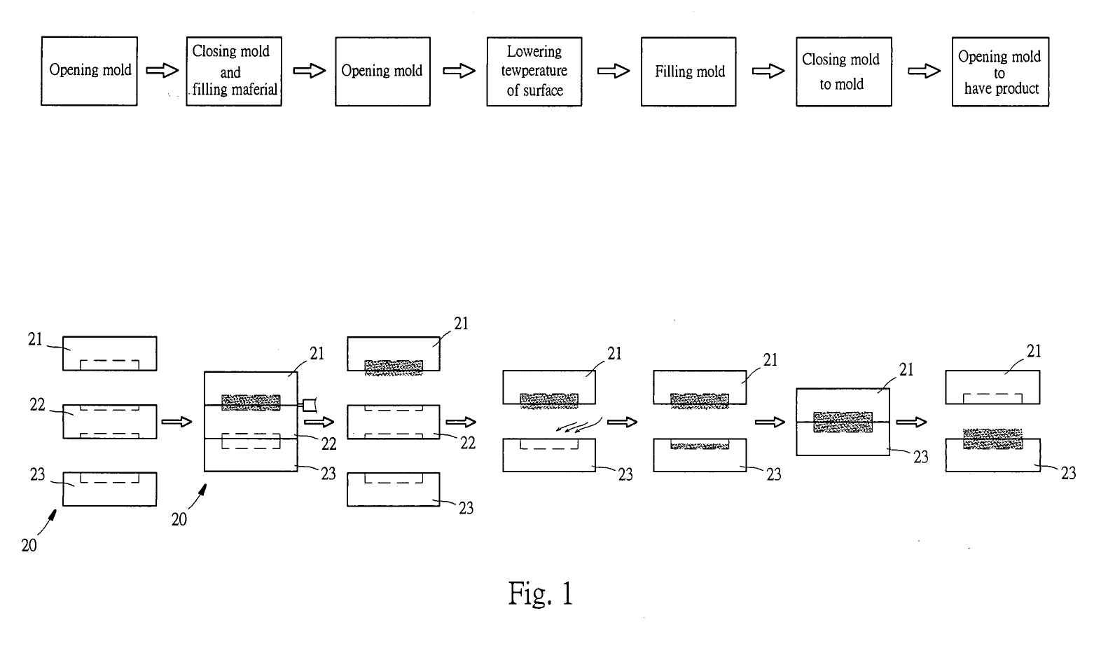

Please refer to FIG. 1 which is a flow chart of the method of the present invention. In a preferred embodiment, the method for filling a blank into a mold of the present invention includes steps of:
a. preparing a multilayer mold (20) composed of an upper mold section (21), a middle mold section (22) and a lower mold section (23) which overlap each other, the mold sections (21, 22, 23) being drivable by an external mold holding mechanism to move relative to each other;
b. overlapping the mold sections (21, 22, 23) and positioning the mold (20) in a first mold-closed position, heat being applied to the mold (20) to make the temperature of the mold (20) rise to a certain extent;
c. quantitatively filling polymer material into a mold cavity defined between the upper mold section (21) and the middle mold section (22) with an injection molding machine, whereby the polymer material is molded into a first blank;
d. separating the mold sections (21, 22, 23) from each other and positioning the mold in a first mold-opened position, the first blank attaching to bottom end of the upper mold section (21) in the mold cavity thereof open to lower side;
e. transversely removing the middle mold section (22) with an external power supply;
f. dispensing a low temperature fluid via a pipeline to impact a surface of the mold cavity of upper end of the lower mold section (23) so as to slightly drop the temperature of the surface;
g. placing a preformed second blank into the mold cavity of the lower mold section (23) cooled by the fluid;
h. mating the upper and lower mold sections (21, 23) with each other and positioning the mold (20) in a second mold-closed position, whereby the mold cavity of lower end of the upper mold section (21) and the mold cavity of the upper end of the lower mold section (23) together form a closed mold cavity in which the first blank and the second blank are mated with each other;
i. applying a certain mold-closing pressure and a certain temperature to the mold (20) positioned in the second mold-closed position necessary for the reaction of the blanks, whereby the blanks have sufficient heat to react in the mold cavity; and
j. separating the upper and lower mold sections (21, 23) from each other after the reaction time of the blanks and positioning the mold (20) in a second mold-opened position, whereby the reaction of the blanks is completed to achieve a product with a desired configuration.

It should be noted that in step c, the first blank can be alternatively molded by means of another conventional polymer molding technique such as pressing. In addition, in step f, the lower temperature fluid can be a low temperature gas carbon dioxide, low temperature gas nitrogen or water. All those fluids without public danger can be used as the low temperature fluid. Also, in step g, the second blank can be filled into the mold cavity by means of different measures as necessary. For example, the second blank can be manually placed into the mold cavity or by means of a certain apparatus.

The above method is characterized in that the temperature of the surface of the mold cavity into which the second blank is to be filled is lowered. Accordingly, after the second blank is filled into the mold cavity and before the mold is closed to mold the blank, the blank is prevented from bending or deforming due to the excessively high temperature of the surface of the mold cavity. Therefore, the quality of the product will not be affected. Moreover, in the method of the present invention, the fluid does not lower the temperature of the entire mold, but only lower the temperature of the surface of the mold cavity. Therefore, after the temperature of the surface is lowered, the time for the temperature to restore can be shortened so that the manufacturing procedure will not be delayed. Therefore, the manufacturing efficiency of the polymer product can be enhanced.

It should be especially noted that in the method for filling the blank into the mold of the present invention, the mold is simply locally cooled, that is, only the surface of the mold cavity is lowered. In actual application, such measure can be combined with other known polymer processing techniques such as injection molding technique.

The above embodiments are only used to illustrate the present invention, not intended to limit the scope thereof. Many modifications of the above embodiments can be made without departing from the spirit of the present invention.

What is claimed is:

1. A method for filling a blank into a mold, the temperature of the mold being previously risen to a predetermined temperature, when the mold is positioned in a mold-opened position, a fluid being used to cool the surface of the mold cavity of the mold into which the blank is to be filled so as to lower the temperature of the surface of the mold cavity, then blank being placed into the mold cavity and the mold being positioned in a mold-closed position.

2. The method for filling the blank into the mold as claimed in claim 1, wherein the fluid flows to contact with the surface of the mold cavity so as to lower the temperature of the surface.

3. The method for filling the blank into the mold as claimed in claim 2, wherein the fluid is ejected from a fluid conveying pipeline.

4. The method for filling the blank into the mold as claimed in claim 1, wherein the fluid is a low temperature gas.

5. The method for filling the blank into the mold as claimed in claim 1, wherein the fluid is water.

6. The method for filling the blank into the mold as claimed in claim 1, wherein the method succeeds to an injection procedure.

7. The method for filling the blank into the mold as claimed in claim 6, comprising steps of:
a. preparing a multilayer mold composed of at least an upper mold section, a middle mold section and a lower mold section;
b. positioning the mold in a first mold-closed position and heating the mold to a certain temperature;
c. quantitatively filling polymer material into a mold cavity defined between the upper mold section and the middle mold section with an injection molding machine, whereby the polymer material is molded into a first blank;
d. positioning the mold in a first mold-opened position;
e. removing the middle mold section;
f. using a low temperature fluid to cool a surface of a mold cavity of upper end of the lower mold section;
g. placing a preformed second blank into the mold cavity of the lower mold section;
h. mating the upper and lower mold sections with each other and positioning the mold in a second mold-closed position, whereby the mold cavity of lower end of the upper mold section and the mold cavity of the upper end of the lower mold section together form a closed mold cavity in which the first blank and the second blank are mated with each other;
i. supplying heat to the mold so as to give the blanks in the mold cavity a temperature necessary for the reaction; and
j. positioning the mold in a second mold-opened position and separating the upper and lower mold sections from each other, whereby the reaction of the blanks is completed to achieve a product with a desired configuration.
